(19) United States
(12) Patent Application Publication
(10) Pub. No.: US 2014/0018504 A1
(43) Pub. Date: Jan. 16, 2014

(54) IMPACT MODIFIER AND USES THEREOF IN THERMOSET MATERIALS

(71) Applicants: Thomas Fine, Lyon (FR); Jean-Loup Lacombe, Billere (FR); Laurent Breysse, Lescar (FR)

(72) Inventors: Thomas Fine, Lyon (FR); Jean-Loup Lacombe, Billere (FR); Laurent Breysse, Lescar (FR)

(73) Assignee: Arkema France, Colombes (FR)

(21) Appl. No.: 14/007,020

(22) PCT Filed: Mar. 23, 2012
(86) PCT No.: PCT/FR2012/050612

§ 371 Date: Sep. 24, 2013

(30) Foreign Application Priority Data
Mar. 25, 2011 (FR) 1152489

(51) Int. Cl. C08F 299/04; B29B 9/06

(52) U.S. Cl. CPC C08F 299/04; B29B 9/065
USPC 525/280; 525/299; 525/289; 264/142; 425/10

(57) ABSTRACT

The present invention relates to an impact modifier and a device and a method for the production thereof, as well as to a method for preparing a thermoset material, or a thermoset material precursor, from the impact modifier. The impact modifier comprises at least one copolymer selected from A-B-A, A-B, and A-B-C block copolymers in which: each block is linked to the other by means of a covalent bond or an intermediate molecule that is connected to one of the blocks by a covalent bond and to the other block by another covalent bond; A is a PMMA homopolymer or a copolymer of methyl methacrylate, A preferably being compatible with the resin; C is either (i) a PMMA homopolymer or a copolymer of methyl methacrylate, or (ii) a polymer based on monomers or a mixture of vinyl monomers, and blocks A and C are identical; and B is incompatible or partially compatible with the thermoset resin and incompatible with block A and optional block C. The impact modifier is characterized in that it takes the form of microgranules having a diameter of less than 1500 μm, and preferably between 400 and 1000 μm. The ratio of the standard-deviation/mean size of the particles is less than 10%, preferably less than 5%.

The present invention relates to an impact modifier, to a device and a method for producing said impact modifier, and to a method for producing a thermoset material, or a thermoset material precursor, from said impact modifier. The invention will find application advantageously within the field of the production of thermoset materials, and especially of thermoset materials with improved impact strength. These materials will be suitable for use in a variety of fields such as aeronautics, electronics, the automobile, or else industry, especially as structural adhesives, as matrices for composite materials, or else as elements for protection of electronic components.

### BACKGROUND OF THE INVENTION

An impact modifier for the purposes of the present patent application is a compound which when mixed with a thermosetting material improves the mechanical properties of the polymerized thermosetting material. This may be manifested, for example, in an improvement in the elongation at break, in the impact resistance, or in the fatigue resistance.

A thermoset material for the purposes of the present patent application is a material formed of polymeric chains with variable lengths which are bonded to one another by covalent bonds so as to form a three-dimensional network. Nonlimiting examples include the following classes of thermosets: epoxy, (meth)acrylic, cyanoacrylate, bismaleimide, unsaturated polyesters, vinyl ester, phenolic and polyurethane.

Thermosets may be obtained by mixing a first, resin part with a second, curing agent part. The impact modifiers may be in one or other of the parts, or in both parts.

The various types of impact modifiers used in thermosetting resins include, for example, impact modifiers which are dissolved in the thermoset precursor before polymerization. These impact modifiers differ from core-shell particle impact modifiers which are dispersed in the precursor before polymerization. The first range of impact modifiers has the great advantage of not needing expensive dispersion tools, and is not subject to segregation or destabilizing effects on the part of the dispersion.

Interest attaches more particularly to the block copolymers which are encountered in the form of pellets or powder, such as those described in patents EP 1 866 369 and EP 1 290 088.

In practice, dissolving the impact modifier in pellet form is undesirable in view of industrial constraints. This is because, fir a simple reason of the exchange surface area to volume ratio, the situation is automatically highly unfavorable. Therefore, in order to manage to dissolve the impact modifier more quickly, the use of an impact modifier in the form of a powder is preferred. This powder may be dissolved in the liquid precursor solution (thermosetting material or curing agent); however, the handling of the powder remains delicate and the dissolution difficult.

The reason is that the grains, when poured into the liquid precursor solution, have a tendency to agglomerate with one another at the surface of the liquid, giving rise to agglomerates which are very difficult to dissolve. In order to curtail this phenomenon, it is necessary to pour the grains very slowly in order to ensure their optimum dispersion in the liquid solution. However, slow pouring cannot always prevent the formation of agglomerates, since the powder, even before being poured, may have a tendency to cake together, in view of the high percentage, of the order of 30% to 60%, of soft phase in the impact modifier in powder form, and the presence of fine particles.

Furthermore, these fine particles generally complicate the manipulation of the impact modifier, and especially its weighing and its metering, and, furthermore, necessitate compliance with the European regulatory framework concerning Explosive Atmospheres (ATEX).

Lastly, these particles in powder form are characterized by a high ratio, greater than 15%, between the standard deviation and the median size of the particles. This very broad particle size distribution randomizes the process of dissolution of these impact modifiers in powder form in the thermosetting precursor.

In light of the drawbacks referred to above, it will be understood that the step of dissolving the impact modifier, as it is presently practiced, is amenable to improvement in terms of convenience and rapidity or else of result with regard to the mixture obtained.

### OBJECT OF THE INVENTION

It is an object of the present invention to present an impact modifier whose structure limits the risks of agglomeration both during its storage and during the step of mixing in the liquid precursor solution.

A further object of the present invention is to propose an impact modifier whose structure facilitates the production of a thermoset material and more specifically of its precursors.

It is a further object of the present invention to provide a device and a method for reliable production of said impact modifier.

### SUMMARY OF THE INVENTION

For this purpose, the invention pertains to an impact modifier for a thermosetting resin, comprising at least one copolymer selected from A-B-A, A-B, and A-B-C block copolymers in which:
each block is joined to the other via a covalent bond or via an intermediate molecule joined to one of the blocks by a covalent bond and to the other block by another covalent bond;
A is a PMMA homopolymer or a methyl methacrylate copolymer;
C is alternatively (i) a PMMA homopolymer or a methyl methacrylate (MMA) copolymer, or (ii) a polymer based on vinyl monomers or a mixture of vinyl monomers; blocks A and C may be identical;
B is incompatible or partly compatible with said resin and incompatible with the block A and, where present, the block C, and its glass transition temperature Tg is less than that of the blocks A and C.

Characteristically said impact modifier takes the form of micropellets with a diameter of between 400 and 1500 μm, and preferably between 400 and 1000 μm, and advantageously between 500 and 800 μm. This characteristic is particularly advantageous since the impact modifier in this form does not undergo caking concentration, either during its storage in dry phase or during its dispersion in the precursor liquid. Furthermore, surprisingly, the rate of dissolution of the impact modifier in micropellet form is greater than or equal to that of the impact modifier in powder form that is used conventionally. Manipulation of these micropellets is also facilitated by the absence of fines generated by the associated production method. Advantageously, the standard deviation/average size ratio of the particles is less than 10%, preferably less than 5%, and advantageously less than 3%. This very narrow particle size distribution for the impact modifier according to the invention provides better control of the process of dissolution in the precursor during the production of thermoset materials.

The present invention likewise pertains to a method for producing an impact modifier as specified above, by a solvent process, said method comprising an extrusion step, an underwater cutting step, and a drying step. According to the invention, the extrusion step is carried out through a die comprising at least one orifice with a diameter of between 0.3 and 0.5 mm, at a die temperature which is dependent on the nature of the impact modifier, and the underwater cutting step is carried out in a pelletizer at a cutting water temperature that produces an impact modifier in the form of micropellets with a diameter of between 400 and 1500 μm, preferably between 400 and 1000 μm.

Extrusion in the context of the invention signifies twin-screw, single-screw, Buss or List extrusion or any other method that allows the impact modifier to be melted and passed through a die.

The invention also pertains to a device for producing an impact modifier, as specified above, wherein the extruder comprises a die with at least one orifice of between 0.3 and 0.5 mm and preferably between 0.35 and 0.37 mm.

The invention, lastly, pertains to a method for producing a thermoset material from said impact modifier.

### BRIEF DESCRIPTION OF THE DRAWINGS

The present invention will be comprehended more fully on the reading of a detailed exemplary embodiment with reference to the appended drawings, which are provided as a nonlimiting example, and in which:

FIG. 1 shows an exemplary embodiment, in front-on view, of a die realized in accordance with the invention,

FIG. 2 shows an embodiment detail, labeled I in FIG. 1, according to the A-A sectional view,

FIG. 3 shows, in front-on view, an exemplary embodiment of a separating grid realized in accordance with the invention,

FIG. 4 shows in 4a) the image of conventional pellets of copolymer 1 exemplified in example 1, while FIG. 4b) shows the micropellets according to the invention that are obtained at the end of the production method of example 1,

FIG. 5 shows a diagram illustrating the continuous measurement over time of the viscosity of two resin mixtures obtained by mixing a precursor and a powder or micropellets.

### DETAILED DESCRIPTION OF THE INVENTION

According to a first aspect, the present invention pertains to an impact modifier for a thermosetting resin, comprising at least one copolymer selected from A-B-A, A-B, and A-B-C block copolymers in which:
each block is connected to the other via a covalent bond or via an intermediate molecule connected to one of the blocks by a covalent bond and to the other block by another covalent bond,
A is a PMMA homopolymer or a methyl methacrylate copolymer; A is preferably compatible with said resin,
C is alternatively (i) a PMMA homopolymer or a methyl methacrylate copolymer, or (ii) a polymer based on vinyl monomers or a mixture of vinyl monomers; blocks A and C may be identical,
B is incompatible or partly compatible with said resin and incompatible with the block A and, where present, the block C.

These A-B, A-B-A or A-B-C block copolymers may be prepared by any means of polymerization. Preference is given to using controlled radical polymerization or anionic polymerization processes, which are employed by a solvent, emulsion, suspension, or other route.

As far as the A-B diblock or ABA triblock is concerned, A is a PMMA homopolymer or a methyl methacrylate copolymer. Where A is a copolymer, the comonomers used are preferably those based on alkyl methacrylate that allow the formation of a block A which is compatible with the thermoset resin. Examples include alkyl methacrylates in which the alkyl group contains from 1 to 18 carbons: methyl methacrylate, ethyl methacrylate, propyl methacrylate, n-butyl methacrylate, t-butyl methacrylate, n-hexyl methacrylate, cyclohexyl methacrylate, 2 ethylhexyl methacrylate, n-octyl methacrylate, lauryl methacrylate, tridecyl methacrylate, stearyl methacrylate, and isobornyl methacrylate. Examples also include all water-soluble comonomers such as acrylic or methacrylic acid, amides derived from these acids, such as, for example, dimethylacrylamide, 2-methoxyethyl acrylate or methacrylate, optionally quaternized 2-aminoethyl acrylates or methacrylates, polyethylene glycol (PEG) (meth)acrylates, water-soluble vinyl monomers such as N-vinylpyrrolidone, or any other water-soluble monomer. Examples additionally include all reactive comonomers which are copolymerized with methyl methacrylate. A reactive monomer is a chemical group capable of reacting with the functions of the thermosetting resins. Block A may be formed by a single one of these (meth)acrylic monomers or by two or more. Examples include hydroxyethyl methacrylate, glycidyl methacrylate, maleic anhydride, and acrylic or methacrylic acid.

Block A may be prepared by any means of polymerization, and more particularly by anionic or controlled radical polymerization.

As far as the block B is concerned, the Tg of B is advantageously less than 0° C. and preferably less than −40° C. By “Tg” is meant the glass transition temperature of a polymer, measured by DSC in accordance with the standard ASTM E1356.

The monomer used for synthesizing the elastomer block B may be a diene selected from butadiene, isoprene, 2,3-dimethyl-1,3-butadiene, 1,3-pentadiene, and 2-phenyl-1,3-butadiene. B is selected advantageously from poly(dienes), especially poly(butadiene), poly(isoprene), and random copolymers thereof, or else from partly or fully hydrogenated poly(dienes). Used advantageously among the polybutadienes are those with the lowest Tg—for example, polybuta-1,4-diene, with a Tg (around −90° C.) lower than that of polybuta-1,2-diene (around 0° C.). Blocks B may also be hydrogenated.

The monomer used for synthesizing block B may also be an alkyl (meth)acrylate, and in that case the Tgs indicated below between parentheses are obtained, following the name of the acrylate: ethyl acrylate (−24° C.), butyl acrylate (−54° C.), 2-ethylhexyl acrylate (−85° C.), hydroxyethyl acrylate (−15° C.), and 2-ethylhexyl methacrylate (−10° C.). Butyl acrylate is used advantageously. Block B may also be composed of a mixture of monomers. The acrylates are different from those of block A, in order to observe the condition of incompatibility between blocks A and B.

In the triblock A-B-C, C is alternatively (i) a PMMA homopolymer or a methyl methacrylate copolymer as defined above, or (ii) a polymer based on vinyl monomers or a mixture of vinyl monomers.

The two blocks A and C of the triblock A-B-C may be identical or different. They may also be different in terms of their molar mass, but composed of the same monomers. If block C contains a comonomer, it may be identical to or different from the comonomer of block A.

As far as (ii) is concerned, examples of blocks C include those which derive from vinylaromatic compounds such as styrene, α-methylstyrene, vinyltoluene, and those which derive from alkyl esters of acrylic and/or methacrylic acids, having from 1 to 18 carbon atoms in the alkyl chain.

Block B is composed of the same monomers and optionally comonomers as block B of the diblock A-B or of the triblock ABA. The blocks B of the triblock A-B-C and of the diblock A-B may be identical or different.

Impact modifiers of these kinds are known for example from document WO 2008/110564, which describes triblock copolymers of type SBM, such as Nanostrength SBM Powder AFX E21, or of type MBM, such as Nanostrength MAM M22, sold by the Applicant. These impact modifiers differ from those according to the invention in the size of their particles (they take the form of powders having an average diameter of less than 240 μm) and in the standard deviation/average size ratio (which is greater than 16%, as shown in example 3 of the present patent application).

The impact modifiers according to the invention take the form of micropellets with a diameter of between 400 and 1500 μm, preferably between 400 and 1000 μm, and advantageously between 500 and 800 μm. The standard-deviation/average size ratio of the particles is advantageously less than 10%, preferably less than 5%, and advantageously less than 3%.

According to a second aspect, the invention relates to a method for producing the impact modifier described above, in the form of micropellets with a diameter of between 400 and 1500 μm, preferably between 400 and 1000 μm, and advantageously between 500 and 800 μm. Conventionally, the line for manufacturing pellets with diameters of a few millimeters comprises a feed system, a pelletizer with an extruder and a die and also underwater cutting means, and the line further comprises a linear conveying unit and means for separating and for drying the pellets.

For the manufacture of micropellets, tests have shown that the production line had to be modified and that particular adaptations were necessary both to the pelletizer and to the drier. The production method must also be modified to give micropellets with a diameter of between 400 and 1500 μm, and preferably between 400 and 1000 μm.

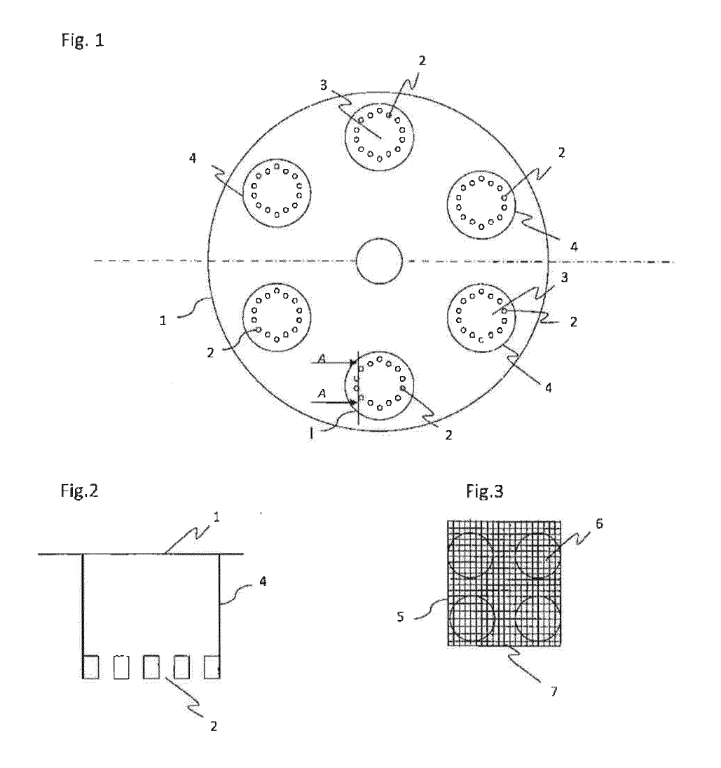

More specifically, and with reference to FIG. 1, a die 1 is shown for the production of micropellets. This die 1 is intended for attachment to the shaft of the pelletizer, which is not shown in the appended figures.

According to the invention, the die 1 comprises at least one orifice 2 of between 0.3 and 0.5 mm and preferably between 0.35 and 0.37 mm.

In the example of FIG. 1, the die 1 comprises orifices 2 distributed as a cluster 3. The die 1 comprises an assembly of clusters 3, each combining a number of orifices 2 of greater than ten. Other configurations are of course envisagable, and the number of orifices 2 distributed over the entirety of the die 1 may readily be modified depending on the features desired for the pelletizer.

According to one advantageous characteristic of the invention, and as shown in FIG. 2, the orifices 2 of the single cluster 3 are distributed in a sink hole 4. This arrangement is advantageous in that it limits the head losses in the die 1.

In the example of FIGS. 1 and 2, the die 1 comprises 6 sink holes 4 each containing a cluster 3. Each duster 3 comprises 15 orifices 2 with a diameter of 0.36 μm. The thickness of the wall at the orifices 2 is of the order of 4 mm, whereas the total thickness of the die is of the order of 55 to 60 mm. The diameter of each sink hole 4 is of the order of 70 mm.

Referring now to FIG. 3, a separating grid 5 is shown, this separating grid 5 comprises openings 6 of circular shape made in a plate 7. The openings 6 advantageously have a diameter of between 1.5 and 2 mm and preferably 1.7 mm. The separating grid 5 further comprises a square-section meshwork 8 disposed on the plate 7, with the space between the meshes between 180 and 220 μm.

Tests have shown that the method for producing pellets of conventional size was not adapted in order to obtain micropellets with a diameter of less than 1.5 mm.

Table 1 below compares different size orders between the pellets produced conventionally and the micropellets of the present invention.

TABLE 1

| Assumptions: | | |
|---|---|---|
| ρ = 920 kg/m3; Q = 60 kg/h | pellets | micropellets |
| Diameter of pellets (mm) | 3 | 0.4 |
| Surface area volume ratio (1/mm) = 6/D | 2 | 15 |
| Weight of 100 pellets (grams) | 1.3 | 0.025 |
| Number of pellets per gram (pellets/g) | 77 | 4000 |
| Surface area of pellets (cm²/g of pellets) | 21.8 | 20.1 |

Owing to the size of the micropellets and of the holes in the die, the micropellets may rapidly block the orifices in the die 1. In order to prevent this phenomenon, the applicant has observed the need to increase the temperature of the die 1. For this purpose, the extrusion step is carried out through a die 1 comprising at least one orifice 2 with a diameter of between 0.3 and 0.5 mm at a die temperature which is sufficiently high to maintain the micropellets in the liquid state.

Furthermore, in view of the substantial ratio between the surface area and the volume of each micropellet, it has been observed that the micropellets cooled down to their core during the underwater cutting step. It is therefore necessary to set a high water cutting temperature in order to cause the water to evaporate up to the surface of the micropellet. To do this the underwater cutting step is carried out in a pelletizer at a cutting water temperature of greater than 70° C.

The two production examples described below were obtained using the die 1 and the square meshwork grid 5 detailed above, and each produced micropellet samples with a diameter of between 400 and 1500 μm, and preferably between 400 and 1000 μm.

The equipment used in the production of examples 1 and 2 also included the following elements:

Feed System

Volumetric metering device

Co-rotating twin-screw extruder Ø 26, length 36D

Gear pump

No filtration

Pelletizer

7 cutters with 45 minute attack angle

Maximum speed 5000 rpm

Line Toward Separator

Length approximately 3 m at DN 40

Flow rate 6 m³/h

Water/Pellet Centrifuge and Drier

Model LPU without agglomerate trap

Rotor at fixed speed 1500 rpm

Area pulsing at pellet exit: blowing 3 seconds/pause 3 seconds

Example 1 of Micropelletizing of Copolymer 1

The impact modifier “copolymer 1” corresponds to the A-B-A triblock copolymer in which A is a copolymer of methyl methacrylate (MMA) and dimethyl acrylamide (DMA) and block B is a homopolymer of butyl acrylate.

Temperatures:

Water: 75° C.

Die: 295° C.

Melt: 221° C.

Micropellets: 45° C.

Melt pressure at 137 bar obtained at approximately 30 kg/h of melt

Pelletizer

7 cutters with 45 minute attack angle

Maximum cutter speed 5000 rpm

Die: 90 holes with diameter of 0.36 mm

Separator/Drier:

Air pulsing every 3 seconds to remove the pellets from the drier outlet drop.

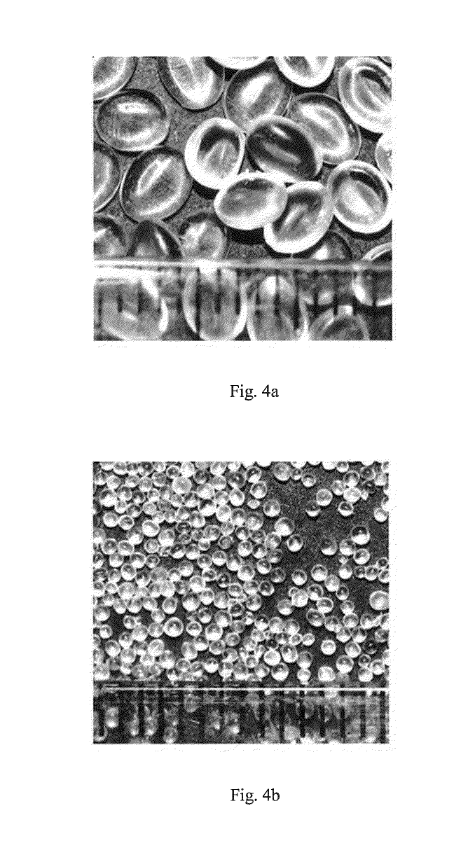

FIG. 4b shows a photograph of micropellets obtained by this first micropelletizing example. Said FIG. 4b indicates that the method employed in this example results in effective control of cutting and in micropellets which are mutually uniform. The conventional pellets obtained from the same copolymer 1 are shown for comparison in FIG. 4a.

The particle size distribution by weight of the micropellets of copolymer 1 is shown in table 2. These results are obtained on passage through a vibrating screen.

TABLE 2

| Size | >1 mm | 1 mm to 800 μm | 800 to 400 μm | 400 to 250 μm |
|---|---|---|---|---|
| Percentage by | 0 | 67.5 | 31 | 1.5 |
| mass ′%) | | | | |

Example 2 of Micropelletizing of Copolymer 2

The impact modifier “copolymer 2” corresponds to the polystyrene-polybutadiene-polymethyl methacrylate copolymer.

Temperatures:

Water: 65° C. then raising to 85° C.

Die: 350° C.

Melt: 225° C. micropellets: 42° C.

Pressure of melt at 132 bar at 16 kg/h

Pelletizer

7 cutters with 45 minute attack angle

Maximum cutter speed 5000 rpm

Die with 90 holes Φ 0.36

This second example produced micropellets with sizes of less than a micrometer.

The particle size distribution by weight of the micropellets of copolymer 1 is shown in table 3. These results are obtained on passage through a vibrating screen.

TABLE 3

| Size | >1 mm | 1 mm to 800 μm | 800 to 400 μm | 400 to 250 μm |
|---|---|---|---|---|
| Percentage by | 0 | 0 | 98.8 | 1.2 |
| mass ′%) | | | | |

The impact modifier in the form of the micropellets that is obtained in examples 1 and 2 may subsequently be used for the production of a thermoset material. The impact modifier in the form of micropellets will therefore be able to be used in a method for producing a thermosetting material or a curing agent.

The method for producing the thermosetting material comprises a step of dissolving, in the precursor, a composition comprising an impact modifier comprising at least one copolymer selected from A-B, A-B-A, and A-B-C block copolymers in the form of micropellets with a diameter of between 400 and 1500 μm, preferably between 400 and 1000 μm, and advantageously of between 500 and 800 μm. The impact modifier is preferably selected from A-B, A-B-A, or A-B-C block copolymers.

It has been observed that the use of an impact modifier for producing the thermosetting material can considerably enhance the production of the thermosetting material.

On the one hand, the problems associated with the agglomeration and the manipulation of the impact modifier in powder form are eliminated, and on the other hand the dissolution of the impact modifier in the form of micropellets surprisingly, a more rapid dissolution than in the form of a powder.

The mechanical properties of the thermosetting material obtained from an impact modifier in the form of micropellets are, furthermore, very close to those of a material obtained from an impact modifier in the powder form.

Comparative tests allow the comparison of the characteristics of resins obtained by mixing a precursor and a powder or micropellets.

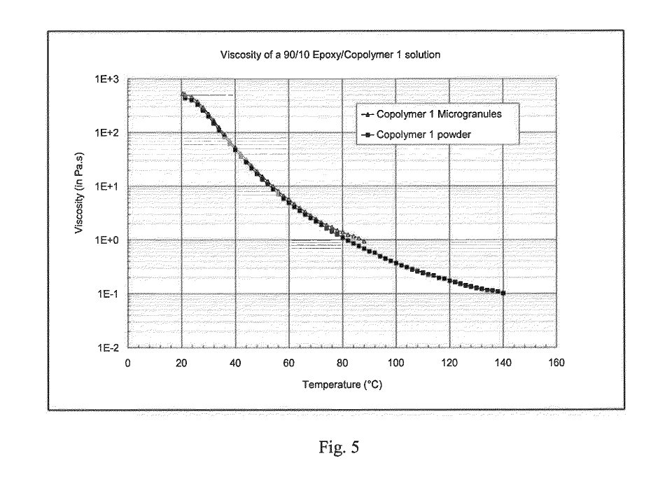

With reference to appended FIG. 5, the continuous measurement over time of the viscosity of the two mixtures can also be seen. The viscosity of the mixture which used the impact modifier in micropellet form is of the same size order as that made with the powder, with the viscosities of each mixture remaining stable over time.

These tests show the advantage of producing a precursor of a thermoset material from an impact modifier in the form of micropellets.

Indeed, the manipulation of the impact modifier is facilitated and the dissolving time of the micropellets in the precursor liquid is reduced relative to the dissolving time of a powder. Other characteristics of the invention could also be envisaged without departing from the scope of the invention as defined by the claims hereinafter.

Example 3 of Comparative Particle Size Analysis of Impact Modifiers: Pellets and Powders

Particle size measurements for impact modifiers according to the invention (in the form of micropellets) and for impact modifiers according to document WO 2008/110564 (in the form of powders) were carried out on the same measuring apparatus (automatic ALPAGA 500 Nano® instrument, developed by the company Occhio).

The evaluations of the study relate to the determination of the average particle size of the following Nanostrength products:

Micro-Pelletized Grades (MG)
E21 10C028 B076#3
M22N 11MG008
M52N 11MG001

Powder Grades (NP)
E21 NP 10M1032
M22N NP 10M 1030
M52N NP 9M1812
   The results are presented in table 4 below.

TABLE 4

| | | | | | % |
|---|---|---|---|---|---|
| | Measure- | Size | Average | Standard | Standard |
| Grade | ment | (μm) | (μm) | deviation | deviation |
| E21 NP 10M1032 | 1 | 284.99 | 233.48 | 39.46 | 17 |
| | 2 | 174.87 | | | |
| | 3 | 230.81 | | | |
| | 4 | 231.84 | | | |
| | 5 | 244.87 | | | |
| M22N NP 10M1030 | 1 | 117.52 | 178.11 | 53.32 | 30 |
| | 2 | 128.08 | | | |
| | 3 | 241.1 | | | |
| | 4 | 208.8 | | | |
| | 5 | 195.04 | | | |
| M52N NP 9M1812 | 1 | 118.41 | 180.66 | 47.16 | 26 |
| | 2 | 156.52 | | | |
| | 3 | 240.43 | | | |
| | 4 | 209.95 | | | |
| | 5 | 178 | | | |
| E21 10C028 B076 | 1 | 694.43 | 691.94 | 3.52 | <1 |
| #3 | 2 | 689.45 | | | |
| M22N 11MG008 | 1 | 755.10 | 751.54 | 5.03 | <1 |
| | 2 | 747.98 | | | |
| M52N 11MG001 | 1 | 658.06 | 647.54 | 14.88 | 2 |
| | 2 | 637.02 | | | |

The average particle size of the grades is as follows:
E21 MG (micropellet): 692 μm on as against 233 μm as grade NP (powder)
M22N MG: 751.5 μm
E21 MG: 647.5 μm as against 233 μm as grade NP.
   The distribution of the sizes demonstrates a polydispersity which is 5 to 6 times greater for the powder grades NP than for the micropellets MG.

1. An impact modifier for thermosetting resin, comprising at least one copolymer selected from A-B-A, A-B, and A-B-C block copolymers in which:
each block is joined to the other via a covalent bond or via an intermediate molecule joined to one of the blocks by a covalent bond and to the other block by another covalent bond;
A is a polymethyl methacrylate (PMMA) homopolymer or a methyl methacrylate (MMA) copolymer;
C is alternatively (i) a PMMA homopolymer or a methyl methacrylate copolymer, or (ii) a polymer based on vinyl monomers or a mixture of vinyl monomers;
blocks A and C are identical or different;
B is an elastomeric polymer which is incompatible or partly compatible with said resin and incompatible with block A and, where present, block C,
characterized in that said impact modifier takes the form of micropellets with a diameter of between 400 and 1500 μm, and in that the standard-deviation/average size ratio of the particles is less than 10%.

2. The impact modifier as claimed in claim 1, wherein the block A is a MMA copolymer and the comonomer is selected from the group consisting of
alkyl methacrylates in which the alkyl group contains from 1 to 18 carbons, methyl methacrylate, ethyl methacrylate, propyl methacrylate, n-butyl methacrylate, t-butyl methacrylate, n-hexyl methacrylate, cyclohexyl methacrylate, 2 ethylhexyl methacrylate, n-octyl methacrylate, lauryl methacrylate, tridecyl methacrylate, stearyl methacrylate, and isobornyl methacrylate;
acrylic acid, methacrylic acid, amides derived from acrylic acid or methacrylic acid, dimethylacrylamide, 2-methoxyethyl acrylate or methacrylate, optionally quaternized 2-aminoethyl acrylates or methacrylates, polyethylene glycol (PEG) (meth)acrylates, and N-vinylpyrrolidone.

3. The impact modifier as claimed in claim 1, wherein the block A is compatible with said resin.

4. The impact modifier as claimed in claim 1, wherein the Tg of the block B is less than 0° C.

5. The impact modifier as claimed in claim 1, wherein the monomer used to synthesize the block B is selected from the group consisting of:
dienes, butadiene, isoprene, 2,3-dimethyl-1,3-butadiene, 1,3-pentadiene and 2-phenyl-1,3-butadiene;
poly(dienes), poly(butadiene), poly(isoprene), and random copolymers of dienes;
partly or fully hydrogenated poly(dienes);
polybutadienes, polybuta-1,4-diene;
alkyl (meth)acrylates, ethyl acrylate, butyl acrylate, 2-ethylhexyl acrylate, hydroxyethyl acrylate, and 2-ethylhexyl methacrylate.

6. The impact modifier as claimed in claim 1, wherein the monomer used to synthesize the block C is selected from the group consisting of vinylaromatic compounds, styrene, alpha-methylstyrene, vinyltoluene, and alkyl esters of acrylic and/or methacrylic acids, having from 1 to 18 carbon atoms in the alkyl chain.

7. A method for producing the impact modifier as claimed in claim 1 comprising an extrusion step, an underwater cutting step, and a drying step, and wherein:
the extrusion step is carried out through a die comprising at least one orifice with a diameter of between 0.3 and 0.5 mm,
the underwater cutting step is carried out in a pelletizer at a cutting water temperature of more than 70° C., to give an impact modifier in the form of micropellets with a diameter of between 400 and 1500 μm.

8. A device for producing an impact modifier as claimed in claim 1, wherein the extruder comprises a die (1) with at least one orifice (2) of between 0.3 and 0.5 mm.

9. The device for producing an impact modifier as claimed in claim 8, wherein the die (1) comprises an assembly of clusters (3) each comprising a number of orifices (2) of more than ten.

10. The device for producing an impact modifier as claimed in claim 8, wherein the die (1) comprises 6 clusters (3) of 15 orifices (2) with a diameter of 0.36 mm.

11. The device for producing an impact modifier as claimed in claim 8, wherein each cluster (3) is disposed in a sink hole (4) in order to reduce the loss of head in the die (1).

12. The device for producing an impact modifier as claimed in claim 8, wherein the separator/drier providing the drying step comprises a separating grid (5) having openings with a diameter of between 1.5 to 2 mm and a square meshwork (6) in which the space between the meshes (6) is between 180 and 220 μm.

13. (canceled)

14. (canceled)

15. The impact modifier as claimed in claim 1, wherein said impact modifier takes the form of micropellets with a diameter of between 400 and 1000 μm, and in that the standard-deviation/average size ratio of the particles is less than 5%.

16. The impact modifier as claimed in claim 4, wherein the Tg of the block B is less than −40° C.

17. The method of claim 7, wherein the underwater cutting step gives an impact modifier in the form of micropellets with a diameter of between 400 and 1000 μm.

18. The device for producing an impact modifier as claimed in claim 8, wherein the extruder comprises a die (1) with at least one orifice (2) of between 0.35 and 0.37 mm.
